(19) United States
(12) Patent Application Publication
(10) Pub. No.: US 2005/0212285 A1
(43) Pub. Date: Sep. 29, 2005

(54) Dual-walled piping system and methods

(75) Inventor: Richard D. Haun, Katy, TX (US)

Correspondence Address: SHAWN HUNTER, P.O Box 270110, HOUSTON, TX, 77277-0110, US

(73) Assignee: OPE International, L.P., Houston, TX (US)

(21) Appl. No.: 11/092,416

(22) Filed: Mar. 29, 2005

Related U.S. Application Data
(60) Provisional application No. 60/557,259, filed on Mar. 29, 2004.

(51) Int. Cl. F16L 9/14

(52) U.S. Cl. 285/123.1

(57) ABSTRACT

Dual-walled piping segments and pipelines are described that use an annular bulkhead to secure the jacket pipe radially outside of the carrier pipe near the axial ends of the piping segment. Pup joints are welded to each end of the carrier pipe, and the bulkheads are welded to the pup joints. The bulkheads have a number of features that provide improved load path control for axial forces induced by temperature differentials. There is a mechanical load-sharing interlock mechanism provided between the bulkhead and the interior pup joint and field joint closure joints designed to transmit stress loading to a plurality of ridges or threads, that may be enhanced by thermal contraction, and preclude axial movement between the jacket pipe and pup joint. A number of methods are described for creating the load-sharing interlock. Additionally, the bulkhead has a generally arcuate cross-section that defines an interior channel. The arcuate cross-section allows the bulkhead to be somewhat flexible to absorb axial and radial loading while reducing the available heat transfer rate. The bulkhead also contains several ports for pressure equalization and plugged ports for the pressure-thermal-chemical conditioning of the annular spaces.

This application claims the priority of U.S. provisional patent application Ser. No. 60/557,259 filed Mar. 29, 2004.

### BACKGROUND OF THE INVENTION

1. Field of the Invention

The invention relates generally to dual-walled piping systems. In particular aspects, the invention relates to details and methods for constructing piping segments and pipelines formed of dual-walled piping segments.

2. Description of the Related Art

Dual-walled pipelines are often used at great depths in the ocean to carry fluids of extreme temperature. The annulus between the inner and outer pipes is typically filled with insulation to minimize fluctuations in temperature while the fluid is in transit through the pipeline. The pipelines are formed of a number of individual dual-walled piping segments that are interconnected in an end-to-end fashion.

One longstanding problem with such pipelines is that temperature differentials between the product being piped and the environment cause great stresses upon the piping segments and, particularly, their connections. The fluids being piped are typically at extreme temperatures, and the function of the dual walled piping is to provide an annular insulated space protected from water ingress. For example, liquid natural gas is piped at a temperature of approximately (−)169° C. Some hydrocarbon products, on the other hand, are transported in pipelines at temperatures between 100°-200° C. Temperature differentials between the interior of the carrier pipe and the exterior of the jacket pipe create significant stresses at the interconnections between the carrier pipe and the jacket pipe. Additionally, stresses occur at, and near, the interconnections between the piping segments. In addition, because the inner carrier pipe and the outer jacket pipe of a pipe segment may be exposed to greatly different temperatures, they can each expand and contract in an axial direction placing high loads and great stress upon the mechanisms used to interconnect the inner and outer pipe segments. The brittleness of metals in extreme cold under the high stresses due to differential contraction can result in catastrophic failures in such pipelines.

A number of prior art piping designs have attempted to solve the pipe in pipe problems, albeit with limited success. U.S. Pat. No. 6,145,547 issued to Villette, for example, describes a dual-walled piping arrangement having an inner tube and outer tube with an open pore-microporous material in between. An end ferrule underlies the outer jacket pipe and is welded to the inner tube. In response to temperature-differential induced forces, tremendous force, hence stress, is placed upon this inter-connection weld. The weld undergoing these high stresses with the commonly recognized stress intensification factors can weaken over time or fail in fatigue cycling, and once broken, would allow sea water to access the annulus and saturate the open pore-microporous material in between. The most troubling issue is controlling the stress levels in closure welds to prevent failures and increase reliability.

### SUMMARY OF THE INVENTION

The present invention provides an improved piping segment and pipeline features as well as methods for construction of these. An exemplary dual-walled piping segment is described that uses an annular bulkhead to secure the jacket pipe radially outside of the carrier pipe near the axial ends of a piping segment. Pup joints are welded to each end of the carrier pipe, and the bulkheads are welded to the pup joints.

The pup joints and bulkheads have a number of features that provide improved load transfer control with resulting reduction of stresses induced by temperature differentials. First, there is a mechanical load-sharing interlock mechanism provided between the bulkhead and the interior pup joint. This mechanism is designed to transmit thermal force loading through a plurality of ridges or threads, that may be enhanced by thermal contraction, and thereby preclude axial movement between the jacket pipe and carrier pipe. A number of methods are described for creating the load-sharing interlock. Additionally, the bulkhead has a generally arcuate cross-section that defines interior channels. The arcuate cross-section allows the bulkhead to be somewhat flexible to absorb axial and radial loading. The cross section also minimizes heat transfer.

Seal welds between the bulkhead and the pup joints provide the means of isolating the insulation in the annulus to ensure thermal efficiency. These isolating seal welds are made on a bulkhead section that is made more flexible by deep annular grooves, or reliefs. Due to the added flexibility afforded by the reliefs, the forces on the seal welds are diverted to the load-sharing interlock reducing the seal weld forces hence the resulting stresses thereby minimizing weld fatigue.

In another aspect, the invention provides for an improved system and method of constructing a dual-walled pipeline consisting of two or more piping segments. The segments are interconnected in an end-to-end fashion using a field joint that engages radially outer sleeve lands on the bulkheads of the two adjoining piping segments. The load-sharing interlock provides means of compensating for pipe length variations as well as providing control in the weld root gap spacing during fabrication. The interlock further reduces heat transfer by interface resistance.

Ports and plugs provide means of filling, emptying and pressure-thermal-chemical conditioning of the annular insulating spaces.

### BRIEF DESCRIPTION OF THE DRAWINGS

For further understanding of the nature and objects of the present invention, reference should be made to the following drawings in which like parts are given like reference numerals and wherein:

FIG. 1 is a side, partial cross-sectional view of an exemplary dual-walled piping segment in accordance with the present invention.

FIG. 1a is an enlarged view of the cutaway portion shown in FIG. 1.

FIG. 1b is a further enlarged cross-sectional view of a bulkhead used within the piping segment, surrounding components, and annulus port and plug.

FIG. 2 is a side, cross-sectional view depicting an exemplary interconnection of two dual-walled piping segments in accordance with the present invention but with annular ports and plugs in alternate locations.

FIG. 3a is a side view, partially in cross-section, of a push-on style of bulkhead now secured to an end of a dual walled piping segment.

FIG. 3aa is an enlarged view of portions of FIG. 3a.

FIG. 3ab is a cross-section taken along lines b-b in FIG. 3aa.

FIG. 3b is a side view, partially in cross-section, of a threaded style of bulkhead now secured to an end of a dual-walled piping segment.

FIG. 3c is a side view, partially in cross-section, of an inverted swaged style of bulkhead now secured to an end of a dual-walled piping segment.

FIG. 4 is a side view, partially in cross-section, of a sliding sleeve style of field joint for interconnection of dual-walled piping segments.

FIG. 5 is a side, cross-sectional detail of an alternative embodiment of the present invention that incorporates a plenum for the seal weld on the carrier pipe.

FIGS. 6, 6A are side, cross-sectional details of an alternative embodiment of the present invention which defines an interconnection arrangement with two pipe-in-pipe segments jointed with an insulated field joint closure.

FIGS. 7A and 7B are side cross-section details of an alternate embodiment that incorporates arcuate cross-sections defining interior channels. The field joint closure is also shown with the same features as well as alternate port and plug locations.

### DETAILED DESCRIPTION OF THE PREFERRED EMBODIMENTS

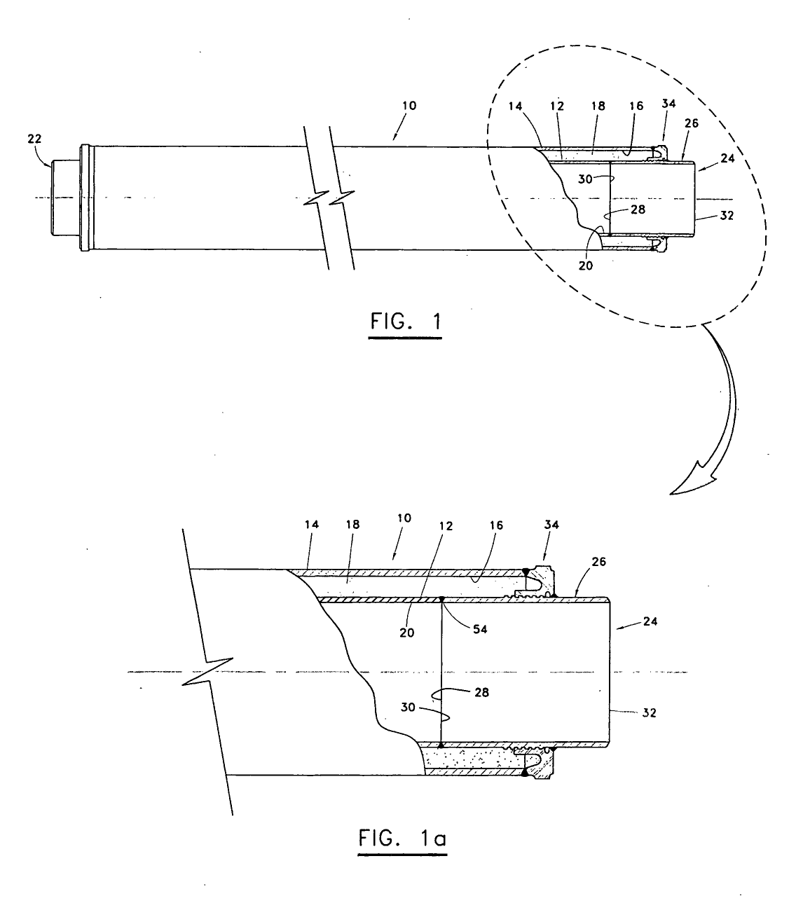

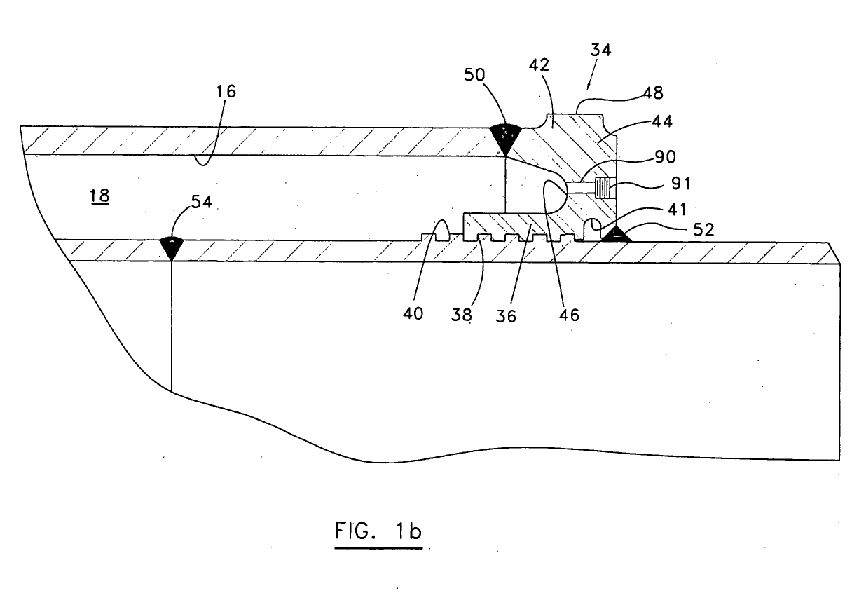

FIGS. 1, 1a and 1b illustrate an exemplary dual-walled piping segment 10 that of a type used within a piping system to transport extreme temperature fluids. The piping segment 10 includes a radially inner carrier pipe 12 and a radially outer jacket pipe 14. The pipes 12 and 14 are preferably formed of steel alloys and other material suited for the thermal, pressure and corrosion issues as containment barriers. An annulus 16 is defined between the carrier pipe 12 and the jacket pipe 14 and is filled with insulating material 18. The carrier pipe 12 defines an axial fluid flow bore 20 along its length. The piping segment 10 has two axial ends 22, 24, which are preferably identical in construction. Details of the axial end 24 are shown in cross-section in FIGS. 1 and 1a. The end 24 includes a radially inner pup joint 26 that is of similar diameter as the carrier pipe 12 with a first axial end 28 that abuts the axial end 30 of the carrier pipe 12. The second axial end 32 of the pup joint 26 is intended to abut a pup joint in an adjacent piping segment.

An annular bulkhead 34 is used to interconnect the outer jacket pipe 14 to the pup joint 26. The structure of the bulkhead 34 is best understood with reference to FIG. 1b. The bulkhead 34 is preferably fashioned of stainless steel, invar or nickel alloyed steel but may be formed of other materials having suitable strength and flexibility. The bulkhead 34 presents a generally arcuate or U-shaped cross-section of a simple form. The bulkhead 34 presents a radially inner portion 36 that presents a roughened, load-bearing inner surface 38. The roughened inner surface 38 is formed to be complimentary to and interlock with roughened outer surface 40 on the pup joint 26. The interlock may be enhanced by press fit or thermal shrinkage between the components. Additionally, an annular relief 41 is formed into the inner portion 36 adjacent the roughened surface 38. The inner portion 36 is interconnected to a radially outer portion 42 by a central web, or hinge, portion 44. A channel 46 is defined between the inner and outer portions 36, 42. Additionally, the outer portion 42 presents a raised land 48. It is noted that the pup joint 26 is welded to the carrier pipe 12 in an end-to-end fashion, as shown by weld 54. A second weld 50 is provided between the bulkhead 34 and the jacket pipe 14, while a third weld 52, a seal weld, is provided to isolate the annular space 16 and secure the bulkhead 34 to the pup joint 26.

The design of the bulkhead 34 and its interconnection with the other components provides relief and absorption of stresses created by temperature differentials. First, a load-sharing mechanical interlock is provided by the engagement of the inner surface 38 of the bulkhead 34 and the outer surface 40 of the pup joint 26. Axial movement between the outer jacket pipe 14 and the inner carrier pipe 14 and pup joint 26 is limited by the interlock, which may be further enhanced by the thermal contraction of the bulkhead 34. Further, axial loads due to contraction or expansion are primarily borne by this interlock due to its high axial stiffness. The arcuate cross-section of the bulkhead 34 also provides flexibility in the connection so that the bulkhead 34 can absorb axial and radial stresses and loading. The web portion 44 of the bulkhead 34 provides a point of flexure between the inner and outer portions 36, 42 about the channel 46. Additionally, the annular relief 41 provides an additional point of flexure within the inner bulkhead portion 36 which provides reduced axial forces hence stresses in the seal weld 52.

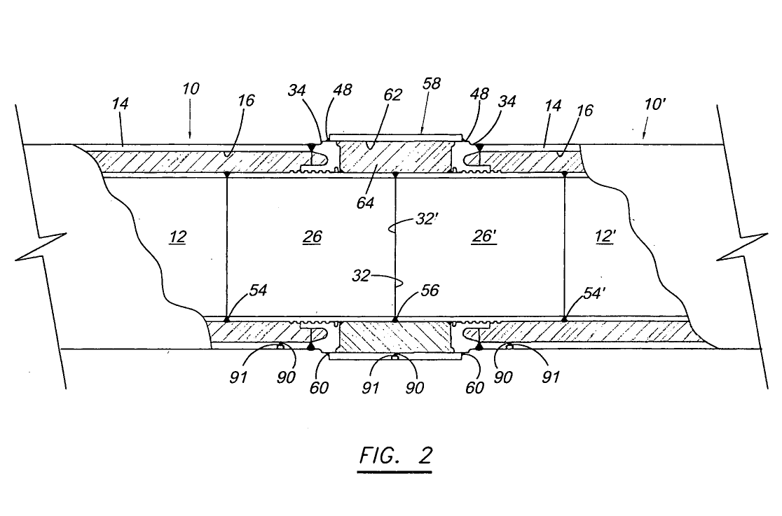

FIG. 2 illustrates an exemplary field joint interconnection of the piping segment 10 with an adjacent piping segment 10′. In this view, cross-hatching is used to depict insulated spaces rather than metal. The distal ends 32, 32′ of the pup joints 26, 26′ are brought into contact with one another and sealed with an annular weld 56. A field joint closure sleeve 58 shown as a single sleeve surrounds the weld 56 and engages the raised sleeve lands 48 of the two bulkheads 34. The closure sleeve 58 is then secured to each of the bulkheads 34 by an annular field joint closure weld 60. An insulation space 62 is defined between pup joints 26, 26′, closure sleeve 58, and the two bulkheads 34. The insulation space 62 is preferably a vacuum or substantial vacuum in order to reduce heat transfer between the inner and outer pipes 12, 14. Additionally, the space 62 is filled with insulation material 64. Port 90 and plug 91 are shown in FIG. 2. These features are preferably provided in lesser stress regions and provide for evacuation of water vapor from the annulus for improved insulation properties.

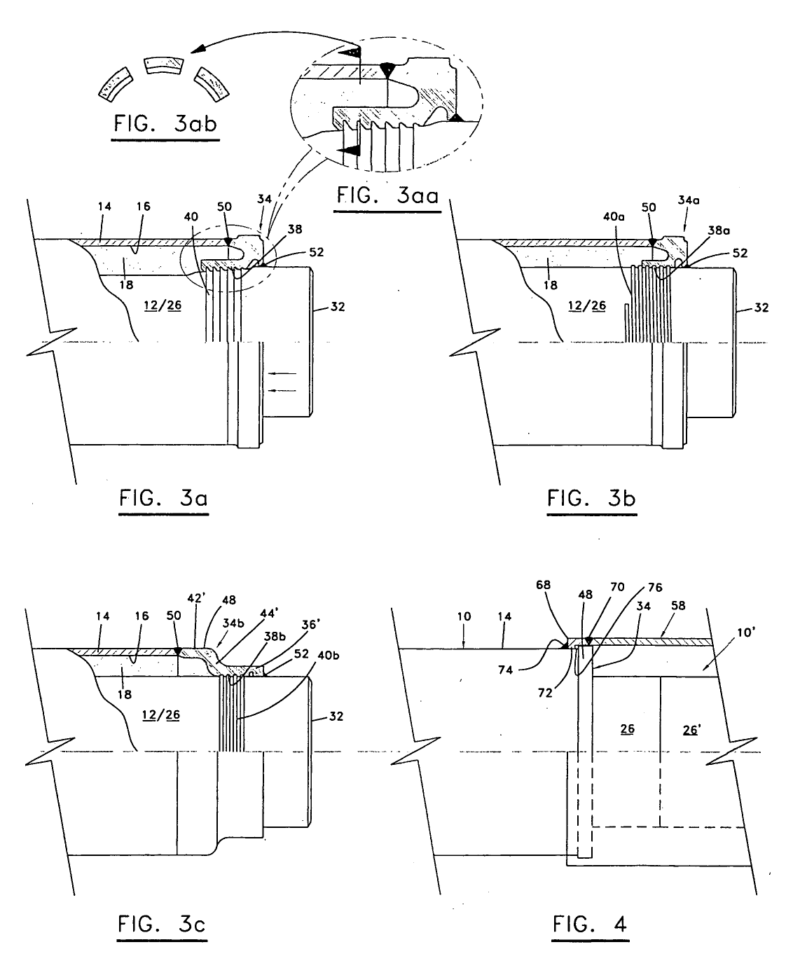

FIGS. 3a, 3aa, 3ab, 3b, and 3c depict alternative methods for providing the load-sharing mechanical interlock between the bulkhead 34 and the pup joint 26/carrier pipe 12. In FIG. 3a, the roughened outer surface 40 is provided by a series of raised, ratchet-style ridges. The bulkhead 34 is secured to the pup joint 26 by first sliding it over the distal end 32 of the pup joint 26 and causing the roughened inner surface 38 of the bulkhead 34 to slide over the ridges of the outer surface 40. The one-way ratchet tooth design of the outer surface 40 precludes movement of the bulkhead 34 in the opposite direction with respect to the carrier pipe 12/pup joint 26. Welds 50 and 52 are then formed. Additionally, as FIGS. 3aa and 3ab depict, the inner portion 36 of the bulkhead 34 is colleted by longitudinal cuts to divide the inner portion 36 into segments, or fingers, 53 that may be radially spread apart from one another to assist in sliding the inner portion 36 onto the distal end 32 and over the outer surface 40. Preheating, or in some cases cooling, the bulkhead 34 with controlled internal diameter dimensions further enhances the load carrying capacity for either cold or hot products. Longitudinal cuts made radially to or near the relief 41 ease the installation by reducing the load requirements for assembly. Tapering of the ridges of the roughened outer surface 40 and/or inner surface 38 assists by taking advantage of the accumulative deflection to allow the addition of larger ridges without overstressing the material.

In FIG. 3b, the roughened outer surface 40a is formed of an outer screw thread that provides a series of individual ridges. The inner surface 38a on the bulkhead 34a is a complimentary thread.

In FIG. 3c, the bulkhead 34b has a somewhat different design, with the inner and outer portions 36′, 42′ being joined by a non-arcuate web or hinge portion 44′ that acts as a point of flexure between the inner and outer portions 36′, 42′. The inner portion 36′ is swaged onto the outer surface 40b using a swaging tool (not shown) of a type known in the art. When swaged, the inner surface 38b of the inner portion 36′ becomes engaged with the outer surface 40b.

Referring now to FIG. 4, there is shown a portion of a further exemplary interconnection of piping segments 10, 10′. A field closure sleeve 58 surrounds the outer jacket pipe 14 of the two piping segments to be joined and rests upon the sleeve lands 48 of the bulkheads 34. An annular sliding sleeve adapter 68 is welded by butt weld 70 to the end of the field closure sleeve 58. The sliding sleeve adapter 68 has a radially inward-projecting portion 72 that contacts the outer surface of the jacket pipe 14. Seal weld 74 is used to secure the adapter 68 to the jacket pipe 14. Shims 76 are preferably positioned between the adapter 68 and the bulkhead 34 to help load the mechanical interlock of the bulkhead 34 with the pup joint 26.

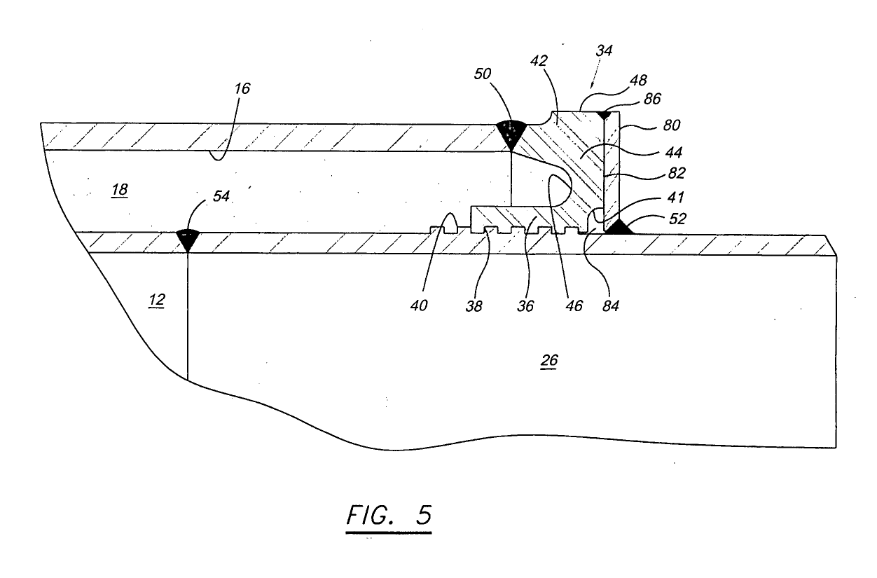

FIG. 5 illustrates a further embodiment for a dual-walled piping segment that incorporates a plenum 80 in conjunction with the annular relief 41 of the bulkhead for reduction of stresses. In this instance, the annular relief 41′ is a chamfered shoulder upon the axial end 82 of the bulkhead 34. The plenum 80 is an annular ring having flattened axial surfaces, in the manner of a washer. The plenum 80 surrounds the carrier pipe 12/pup joint 26, and a chamber 84 is formed between the bulkhead 34 and the plenum 80. Bead weld 52 secures the plenum 80 to the carrier pipe 12/pup joint 26. An additional weld bead 86 secures the plenum 80 to the bulkhead 34. In operation, this arrangement provides for stress loading upon the mechanical interlock (formed by inner surface 38 and outer surface 40). At the same time, the plenum 80 may deform in order to absorb deflection caused by clearances in the mechanical load-sharing interlock sections 38 and 40 while undergoing low fatigue stress.

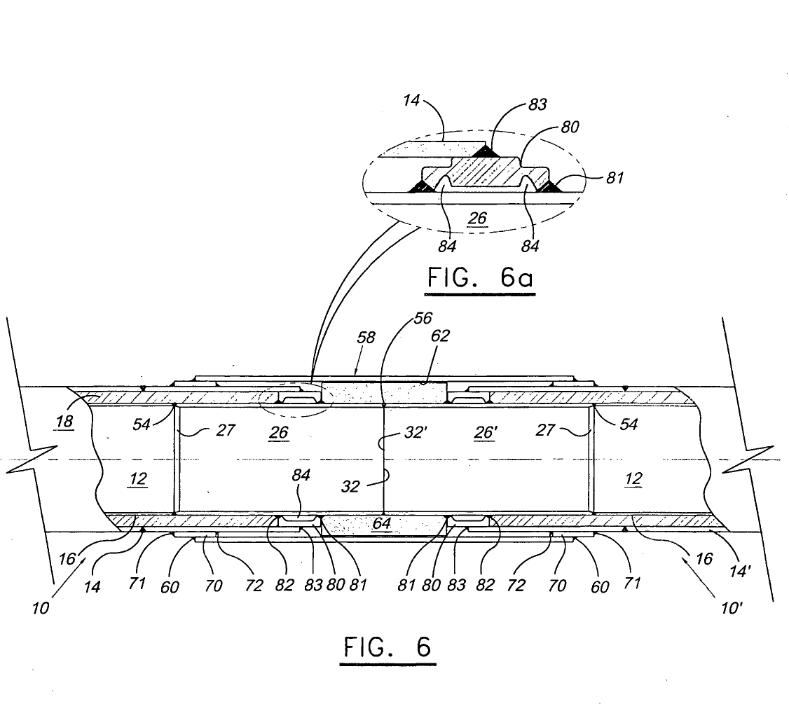

FIG. 6 illustrates a further embodiment field joint interconnection of the piping segment 10 with an adjacent piping segment 10′. In this view, cross-hatching is used to depict insulated spaces rather than metal. The distal ends 32, 32′ of the pup joints 26, 26′ are brought into contact with one another and sealed with an annular weld 56. A field joint closure sleeve 58 surrounds the weld 56 and engages the raised sleeves 70 as a substitute for land 48 in FIG. 2. The closure sleeve 58 is then secured to each of the raised sleeves 70 which, in turn, are attached by welds 71 and 72 to outer jacket pipes 14 and 14′. Each outer jacket pipe 14 and 14′ is, in turn, attached to a bulkhead ring 80 by weld 83. Bulkhead ring 80 is of such configuration to provide fully ultrasonic inspectable welds 81, 82 which connect to the carrier pipe pup joint 26. Pup joint 26 is shown to be a thicker pipe section and has a transition 27 for the weld 54 to the carrier pipe 12. A single relief 84 is shown in FIG. 6 while FIG. 6A presents dual reliefs by a modification in the shape of the bulkhead ring 80. This configuration, while not containing the adjustable features of the exemplary bulkhead system, presents economic advantage for those portions of a system where conditions and stress levels are found to be suitable. An insulation space 62 is defined between pup joints 26, 26′, closure sleeve 58, and the two bulkheads 34 and is filled with insulation material 64.

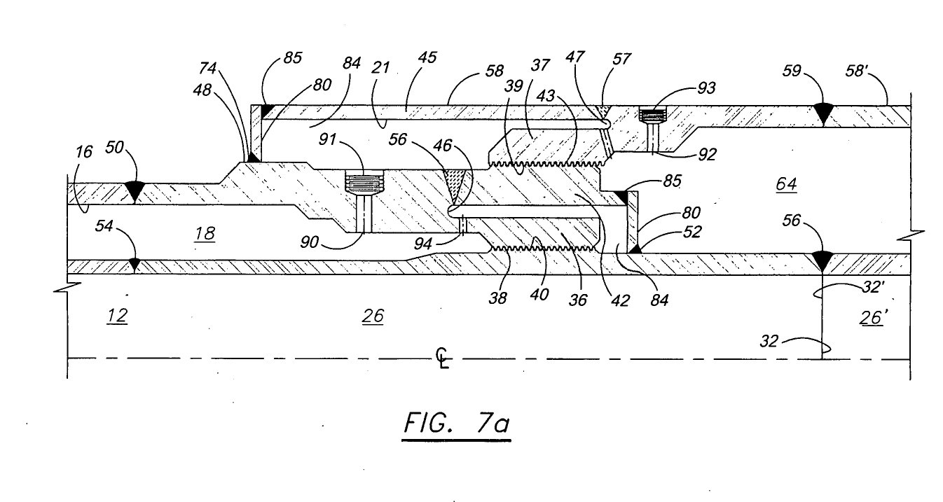

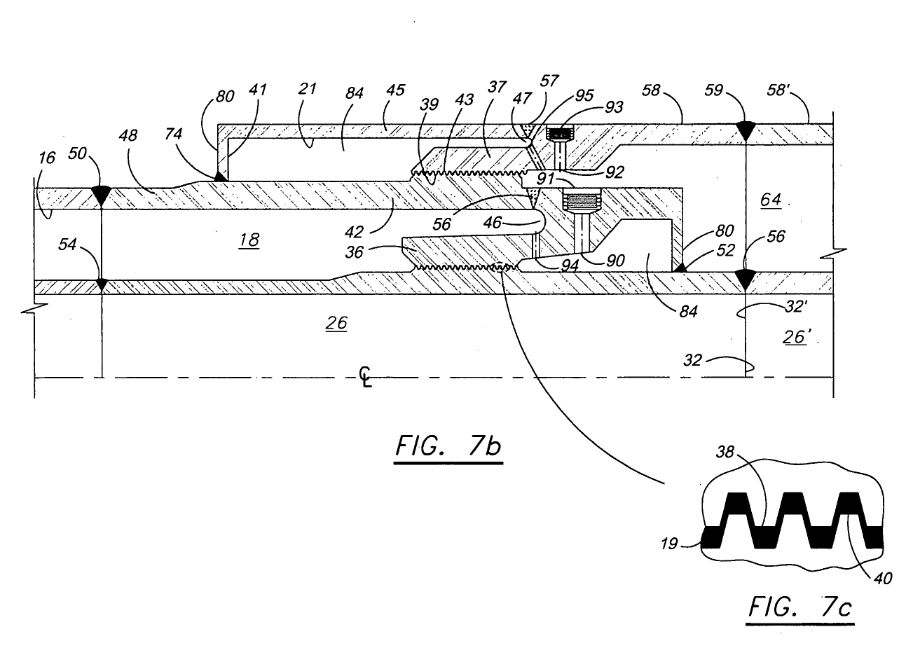

FIGS. 7a and 7b illustrate further embodiments for piping systems wherein the field joint closure is composed of two portions 58 and 58′ with an adjoining butt weld 59 and seal welds as shown by 74. The systems shown in FIGS. 7a and 7b differ in that the relative diameter of sleeve lands 48 is of greater diameter the than roughened surface 40 in FIG. 7A and less than roughened surface 40 in FIG. 7B. These differences allow the field joint closure halves 58 and 58′ to be either pre-installed over piping segments 10 and 10′ or installed separately. These feature differences are beneficial in field assembly procedures involving the handling of straight and curved bulkhead end segments for ease of construction and control of stresses. Providing the ability to pre-install the field closure halves 58 and 58′ over the piping segments allows for offshore lay barge installation. Providing the ability to add the field closure halves 58 or 58′ at assembly allows for tie-in spool fit-up operations in the field.

As a further embodiment of the invention, within FIGS. 7a and 7b, are inner and outer sections 36 and 42 for the inner bulkhead and 37 and 45 for the outer bulkhead are shown to be fabricated of segments forming arcuate sections with joining welds 56 and 57. These features allow for the most efficient thermal insulating paths due to the added lengths and reduced areas plus yield and an efficient means of machining ports 94 and 92 for pressure equalization across the interlocking surfaces 38, 40 and 39, 43. When the arcuate features are as shown in FIGS. 7a and 7b, the heat transfer is greatly minimized while also minimizing stress levels for long fatigue life. The use of the roughened or mechanical interlock surfaces, 40 and 43 and their mating surfaces 38 and 39, greatly increases the resistance to heat transfer due to thermal interface resistance recognized as a problem when heat transfer efficiency is the objective. The quantity of heat transferring decreases with reduced area; decreases with an increase in the length of the flow path and decreases with an increase of material and surface-to-surface (interface) thermal resistance. Advantage of thermal interface resistance is further taken advantage of by use of poorly conducting thread lubricants 19 as shown in FIG. 7c. Preferred lubricants are those which can tolerate the environmental temperature ranges and allow for the addition of insulating materials such as Teflon, a material with lubricity and thermal resistance.

Also illustrated in FIGS. 7A and 7B are the use of pressure equalizing ports 94 and 95 and ports 90, 92 and plugs 91, 93 to allow pressure testing of the seal welds 52, 74, the butt welds 50, 54, 56, 59 and the removal of water vapor and temperature/pressure conditioning of the annular spaces 16 and 21. Also illustrated in FIG. 7A are the duplicate use of plenums 80 with attachment welds 85 and seal welds 52 and 74. FIG. 7B illustrates the use of two annular reliefs 41 in lieu of plenums 80 to provide low stress and long fatigue life for seal welds 52, 74.

Those of skill in the art will recognize that numerous changes and modifications may be made to the exemplary systems and methods described herein without departing from the scope and spirit of the invention. In fact, the invention is intended to be limited only to the claims which follow and all permissible equivalents thereof.

1. A dual-walled piping segment comprising:
a carrier pipe;
a jacket pipe radially outside of the carrier pipe; and
a bulkhead securing the carrier and jacket pipes together in a generally coaxial relation, the bulkhead comprising:
an annular outer portion;
an annular inner portion lying radially within the outer portion; and
a web portion interconnecting the inner and outer portions to provide a point of flexure for the inner and outer portions.

2. The dual-walled piping segment of claim 1 wherein the annular inner portion presents an inner engagement surface having means for interlocking the bulkhead with a pup joint for load transfer path control of axial forces.

3. The dual-walled piping segment of claim 1 wherein the bulkhead presents a generally U-shaped arcuate cross-section.

4. The dual-walled piping segment of claim 3 wherein the arcuate cross-section provides a path of higher resistance to heat transfer.

5. The dual walled piping segment of claim 1 further comprising a pup joint that lies coaxially with and abuts the carrier pipe.

6. The dual-walled piping segment of claim 2 wherein the means for interlocking comprises a roughening of the inner engagement surface.

7. The dual-walled piping segment of claim 2 wherein the means for interlocking comprises a threaded engagement.

8. The dual-walled piping segment of claim 2 wherein the means for interlocking comprises a plurality of ratchet-style ridges.

9. The dual-walled piping segment of claim 8 wherein the inner portion of the bulkhead is further formed into a plurality of colleted fingers by at least one longitudinal cut to ease assembly requirements.

10. The dual-walled piping segment of claim 2 further comprising an annular relief formed upon the inner surface of the bulkhead to reduce the forces and fatigue stresses in the assembly and welds.

11. The dual walled piping segment of claim 1 further comprising an insulating material disposed between the carrier pipe and jacket pipe.

12. The dual walled piping segment of claim 2 further comprising an annular plenum secured to the bulkhead and the pup joint for reduction of stress due to accumulation of thermal and stress related strain.

13. The dual walled piping segment of claim 12 further comprising a chamber formed between the bulkhead and the plenum for unimpeded strain absorption.

14. A dual walled pipeline for the transport of fluids, comprising:
an outer jacket pipeline formed of a plurality of jacket pipe members, each of the jacket pipe members having an axial end and at least one radially outwardly projecting land proximate the axial end;
an inner carrier pipeline formed of a plurality of inner carrier pipe members;
first and second bulkheads that secure the outer jacket pipeline to the inner carrier pipeline; wherein the inner carrier pipes present an inner engagement surface for interlocking the bulkheads with the inner carrier pipes for control of the load path for axial forces;
a field joint joining at least two of said jacket pipe members together in sequential coaxial fashion, the field joint comprising a field closure sleeve secured to the first and second bulkheads wherein the outer carrier pipes present an inner engagement surface for interlocking the bulkheads with the field joint for control of the load path for axial forces.

15. A dual-walled pipeline for transport of fluids, the pipeline comprising:
an inner carrier pipe;
an outer jacket pipe radially surrounding the carrier pipe;
a pup joint that lies coaxially with and abuts the carrier pipe;
a bulkhead interconnecting the outer jacket pipe to the pup joint, the bulkhead comprising:
an annular outer portion;
an annular inner portion lying radially within the outer portion and secured by a locking engagement to the pup joint; and
a web portion interconnecting the inner and outer portions to provide a point of flexure for the inner and outer portions and a path of increased resistance to heat transfer.

16. The dual walled pipeline of claim 15 further comprising an insulating material disposed between the jacket pipe and the carrier pipe.

17. The dual walled pipeline of claim 15 further comprising an annular relief formed upon an inner engagement surface of the bulkhead to assist in absorption of axially induced deflections with low force and resulting low fatigue stress.

18. The dual-walled pipeline of claim 15 wherein the locking engagement comprises a threaded connection between the bulkhead and the pup joint.

19. The dual-walled pipeline of claim 15 wherein the locking engagement comprises a plurality of ratchet-style ridges upon the pup joint that are interengaged with complimentary ridges upon the bulkhead.

20. The dual-walled pipeline of claim 15 wherein the inner portion of the bulkhead is formed into a plurality of colleted fingers by at least one longitudinal cut to ease assembly requirements.

21. The dual walled pipeline of claim 15 wherein an annular space is defined between the inner and outer pipes and wherein the annular space is substantially a vacuum to reduce heat transfer.

22. The dual walled pipeline of claim 15 further comprising a series of ports to equalize pressure on either side of the locking engagements.

23. The dual walled pipeline of claim 15 further comprising a series of ports and plugs to allow pressure and thermal conditioning of the annular spaces and to allow testing of seal and butt welds.

24. The dual walled pipeline of claim 15 further comprising locking engagement surfaces in which low conductive materials are used to coat the contact surfaces to further increase the thermal interface resistance.
